(19) United States
(12) Patent Application Publication
(10) Pub. No.: US 2013/0110912 A1
(43) Pub. Date: May 2, 2013

(54) SYSTEM AND METHOD FOR PROVIDING ANONYMOUS INTERNET BROWSING

(71) Applicant: Marc Elkowitz, Old Westbury, NY (US)

(72) Inventor: Marc Elkowitz, Old Westbury, NY (US)

(21) Appl. No.: 13/666,492

(22) Filed: Nov. 1, 2012

Related U.S. Application Data
(60) Provisional application No. 61/554,779, filed on Nov. 2, 2011.

(51) Int. Cl. H04L 29/08

(52) U.S. Cl. CPC H04L 67/02
USPC 709/203

(57) ABSTRACT

A system and method for providing anonymous internet browsing on a client device. A client computer device access a remotely located computer browsing agent wherein a proxy connection is preferably established between the browsing agent and the client computer device. The browsing agent is instructed to access a requested website via instructions received from the client device. The requested website is loaded on the browsing agent. A graphical representation of the loaded website is provide on a browser associated with the client device, via the proxy connection.

### CROSS REFERENCE TO RELATED APPLICATIONS

This application claims priority to U.S. Patent Application Ser. No. 61/554,779 filed Nov. 2, 2011 which is incorporated herein by reference in its entirety.

### FIELD OF THE INVENTION

The invention generally relates to a remote internet browsing agent, and more particularly, to a system and method for providing anonymous and history free internet browsing on a user computering client device.

### BACKGROUND OF THE INVENTION

The Internet is a global network of millions of computers belonging to various commercial and non-profit entities such as corporations, universities, and The Internet is a global network of millions of computers belonging to various commercial and non-profit entities such as corporations, universities, and research organizations. The computer networks of the Internet are connected by gateways that handle data transfer and conversion of messages from a sending network to the protocols used by a receiving network. The Internet's collection of networks and gateways use the TCP/IP protocol. TCP/IP is an acronym for Transport Control Protocol/Internet Protocol, a software protocol developed by the Department of Defense.

The increasing use of wide area networks such as the Internet has resulted in an explosion in the provision of on-line services. Computer users can access a vast wealth of information and services by utilizing a wide area network to establish a connection with other computers connected to the network.

Typically, the computers connected to a wide area network such as the Internet are identified as either servers or clients. A server is a computer that stores files that are available to other computers connected to the network. A client is a computer connected to the network that accesses the files and other resources provided by a server. To obtain information from a server, a client computer makes a request for a file or information located on the server using a specified protocol. Upon receipt of a properly formatted request, the server downloads the file to the client computer.

The World Wide Web is a system of Internet servers using specified Internet protocols and supporting specially formatted documents. The HyperText Transfer Protocol (“HTTP”) is the underlying protocol used by the World Wide Web. HTTP defines how messages are formatted and transmitted, and what actions Web servers and browsers should take in response to various commands. The other main standard of the World Wide Web is Hyper-Text Markup Language (“HTML”), which covers how documents and files are formatted and displayed. HTML supports links to other documents, as well as graphics, audio, and video files.

Users access the content contained on the Internet and the World Wide Web with an Internet Browser, which is a software application used to locate and display web pages. A Web page is a document on the World Wide Web. Every Web page or file on a web server is identified by a unique Uniform Resource Locator. A Uniform Resource Locator (“URL”) is the global address of files and other resources on the Internet. The address indicates the protocol being used and specifies the IP address or the domain name where the file or resource is located. Typically, a URL identifies the name of the server and the path to a desired file on the server. For example, a URL for a particular file on a web server may be constructed as follows: “http://<server>/<filepath>”, where <server> identifies the server on which the file is located and <filepath> identifies the path to the file on the server. Thus, with the name of the server and the correct path to a file, a properly formatted URL accesses a desired file on a server connected to the World Wide Web.

A problem exists when a user desires to remain anonymous to a visited Web page. This is because, first, when a browser on a user's client computering device is used to access a webpage, the user's browser will store data (e.g., cached history, java, cookies and the like) relating to this web page in memory on the user's client computering device, which is often difficult to remove. Secondly, the server agent will likewise retain a history of all client computering devices which requested access to its web page files.

Accordingly, a need exists for a method and system that enables a user to remain anonymous while they browse the Internet leaving no history of their access thereto on their local client computer device or the server agent.

### SUMMARY OF THE INVENTION

In one aspect, provided is a system and method for providing anonymous internet browsing on a client device. A client computer device access a remotely located computer browsing agent wherein a proxy connection is preferably established between the browsing agent and the client computer device. The browsing agent is instructed to access a requested website via instructions received from the client device. The requested website is loaded on the browsing agent. A graphical representation of the loaded website is provide on a browser associated with the client device, via the proxy connection.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is an illustrated embodiment of a computering device used with the present invention; and

FIG. 2 is an illustrative embodiment of a system level diagram depicting the present invention.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

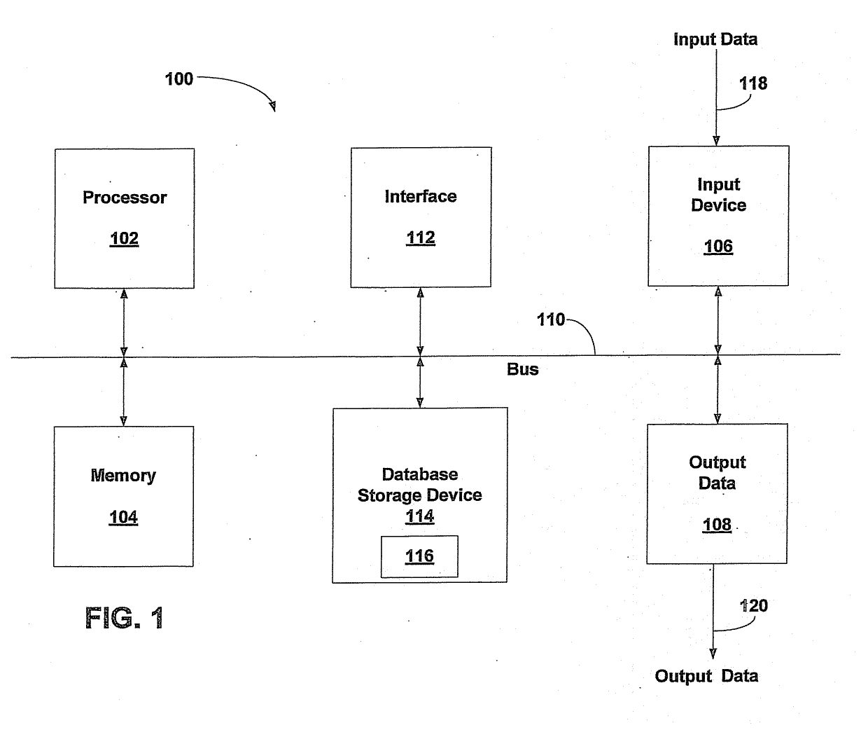

Turning now descriptively to the drawings, in which similar reference characters denote similar elements throughout the several views, FIG. 1 depicts an exemplary general-purpose computing system in which illustrated embodiments of the present invention may be implemented.

A generalized computering embodiment in which the present invention can be realized is depicted in FIG. 1 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a tablet device, a handheld device (e.g., smart phone), a server, a router, a network PC, a peer device, or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, smart phone devices (e.g., and Andriod or iPhone device), a tablet device (e.g., an iPad), multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

With the exemplary computing system environment 100 of FIG. 1 being generally shown and discussed above, a brief description of the invention will now be described.

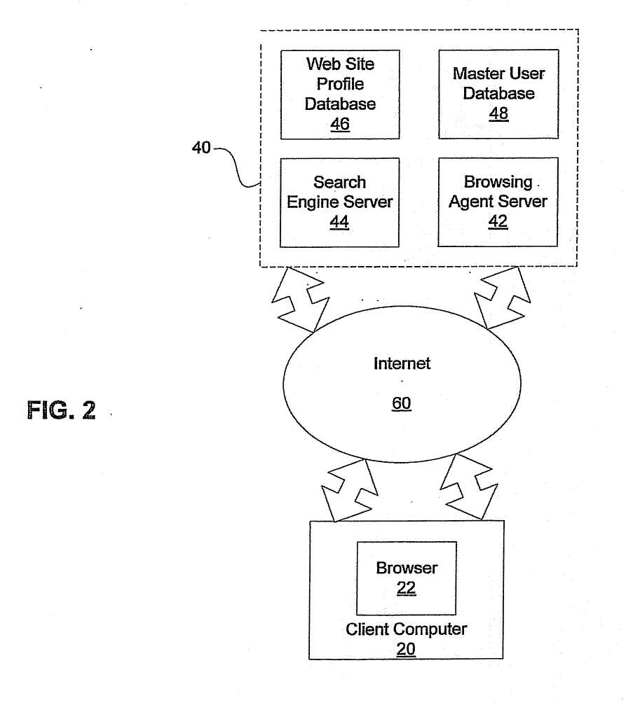

With reference now to FIG. 2, shown is at least one client computering device 20 and browsing agent site 40, all of which are connected to the Internet 60. Of course, one skilled in the art will recognize that the present invention can be applied to any wide area and, in some embodiments, local area computer networks. Moreover, suitable computer networks include an electronic computer network, an optical computer network, a wireless computer network, and/or any combination of the foregoing. The system illustrated in FIG. 2 shows the communication paths going through a browsing agent server as a proxy server. Those skilled in the art will know that the implementations illustrated in FIG. 2 are possible and that the architectures represented therein offer different engineering trade-offs. It is to be further understood and appreciated that while FIG. 2 shows only a single client computering device 20 coupled to the browsing agent site, via Internet 60, this is only for ease of illustration purposes as the present invention is intended to couple a plurality of client computering devices, preferably each of a differing configuration.

As FIG. 2 illustrates, one illustrated embodiment of the present invention works in conjunction with a conventional computer 20 having an Internet browser 22 and a connection to the Internet 60. The user's computer 20 can be any conventional computering device known in the art and as discussed above with reference to FIG. 1. In preferred form, user computer 20 includes at least one processor, a data storage system (including volatile and non-volatile media), a keyboard, a display device (such as a CRT, LCD, or LED display), at least one input device and at least one output device. In one preferred embodiment, the user's computer is connected to the Internet via a modem dial-up connection or through a network line (such communication could also be wireless) as again discussed above with reference to FIG. 1.

Browsing agent site 40, in accordance with the illustrated embodiment of FIG. 2, is supported by servers 42 connected to the Internet 60. Browsing agent servers 42 preferably receive data from browser 22 and transmit control data in response. In the illustrated embodiment of FIG. 2, browsing agent site 40 may includes a search engine server 44, web site profile database 46, and master user database 48. Web site profile database 46 and master user database 48 can be any database known in the art. In one embodiment, each database is implemented in hardware including a collection of computer programs enabling the storage, modification, and extraction of information on the database. Database hardware may range from personal computers (for small systems) to mainframes (for large systems). In addition, browsing agent servers 42 may be implemented in hardware or software, or preferably a combination of both. In preferred form, the server is implemented in computer programs executing on programmable computers each comprising at least one processor, a data storage system (including volatile and non-volatile media), at least one input device, and at least one output device. As is more fully described below, browsing agent servers 42, in one embodiment, receive data from browser 22, perform certain pre-defined actions based on the transmitted data, and transmit data back to browser 22. As one skilled in the art will recognize, however, the databases described above may reside on browsing agent server 42 or may be physically separate, but operably connected thereto.

In use, when user of computer device 20 desires to browse web sites on the internet 20 in anonymity, the user accesses browsing agent site 40, via browser 22, preferably via a web site associated with browsing agent 40. Once an internet connection (e.g., a proxy connection) is established with remote browsing agent site 40, via user browser 22, remote browsing agent 40 is adapted and functional to enable a user, via user browser 22, to essentially instruct browsing agent 40 to establish a proxy connection with the user desired web site based upon the user inputted data. Thus the proxy connection and all related data (history cache, java tags, cookies and the like) are established and stored on the remote browsing agent 40, and not the user computer device 20.

Next, the browsing agent 40 loads the requested website via it's established proxy connection therewith. The graphical results of the user requested website loaded on the browsing agent 40 are then merely displayed on the user's browser 22. It is to be appreciated and understood no historical data related to the user requested loaded website are stored on the user's computer 20 as no proxy is established between the user's computer 20 and the user requested website. The proxy established between the user's computer 20 and the browsing agent 40 does not contain any data related to the user requested website other than a graphical representation of the loaded results. Thus, the user's access to the aforesaid user requested website is anonymous. Additionally, once the user terminates the proxy between the user's browser 22 and the remote browsing agent 40, the remote browsing agent 40 may be configured and adapted to automatically delete all historical data relating to access to the aforesaid user requested website.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

The above presents a description of a best mode contemplated for carrying out the present invention and of the manner and process of making and using them, in such full, clear, concise, and exact terms as to enable any person skilled in the art to which it pertains to make and use these devices and methods. The present invention, however, susceptible to modifications and alternative method steps from those discussed above that are fully equivalent. Consequently, the present invention is not limited to the particular embodiments disclosed. On the contrary, the present invention encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A method for providing anonymous internet browsing on a client device, comprising:
accessing a computer browsing agent using a remotely located client computer device;
establishing a proxy connection between the browsing agent and the client computer device;
instructing the browsing agent to access a requested website via instructions received from the client device;
loading the requested website on the browsing agent; and
viewing a graphical representation of the loaded website on a browser associated with the client device, via the proxy connection.
